(19) United States
(12) Patent Application Publication
(10) Pub. No.: US 2015/0067612 A1
(43) Pub. Date: Mar. 5, 2015

(54) METHOD AND APPARATUS FOR OPERATING INPUT FUNCTION IN ELECTRONIC DEVICE

(71) Applicant: Samsung Electronics Co., Ltd., Suwon-si (KR)

(72) Inventors: Byoungwook YANG, Daegu (KR); Hyesoon JEONG, Chilgok-gun (KR); Kyuchul KONG, Gumi-si (KR); Seongyoon SEOK, Daegu (KR); Yunjeong CHOI, Gumi-si (KR)

(21) Appl. No.: 14/469,979

(22) Filed: Aug. 27, 2014

(30) Foreign Application Priority Data
Aug. 28, 2013 (KR) 10-2013-0102302

(51) Int. Cl. G06F 3/0481; G06F 3/0484

(52) U.S. Cl. CPC G06F 3/04812; G06F 3/04842
USPC 715/856

(57) ABSTRACT

A method and an apparatus for operating an input function by a cursor of an electronic device are provided. The method includes executing, by the electronic device, a character input mode, providing a cursor handle to support an input function in the character input mode, and changing the cursor handle in response to a user input. The present disclosure may be implemented by various embodiments based on any embodiment of this specification.

### CROSS-REFERENCE TO RELATED APPLICATION(S)

This application claims the benefit under 35 U.S.C. §119(a) of a Korean patent application filed on Aug. 28, 2013 in the Korean Intellectual Property Office and assigned Serial number 10-2013-0102302, the entire disclosure of which is hereby incorporated by reference.

### TECHNICAL FIELD

The present disclosure relates to a method and an apparatus for operating an input function by a cursor in an electronic device.

### BACKGROUND

Recently, with a development of digital technology, various electronic devices (e.g., a mobile communication terminal, a Personal Digital Assistant (PDA), an electronic notebook, a Smart Phone, a tablet Personal Computer (PC), etc.) capable of processing communication and personal information are released. Electronic devices have reached a mobile convergence stage which covers even an area of other terminals without staying in their own traditional area. For instance, an electronic device may include various functions, for example, call functions such as a voice call and a video call, message transmission and reception functions such as Short Message Service (SMS), Multimedia Message Service (MMS) and e-mail, a navigation function, a photographing function, a broadcasting play function, a multimedia (video and music) play function, an Internet function, a messenger function, Social Networking Service (SNS) functions, and the like.

In the meantime, in general, a user may input various characters (letters, numbers, figures, etc.) by using handwriting or a keypad in the electronic device. In addition, the user may use a cursor to edit (e.g., designating a block for selecting a character) or correct a character inputted during the input of the character in the electronic device. For example, the user may frequently require correcting the inputted character due to a typing error. In this case, the user may edit or correct a corresponding character by moving the cursor to a location of a typing error to be edited or corrected. The cursor may represent a mark indicating a location displaying a character on a screen of the electronic device. For example, the character inputted through a keypad by the user may be displayed at a location of a cursor on the screen, and simultaneously, the cursor may be moved to the right one by one. In general, the cursor blinks to indicate that character can be inputted, which is referred to as a cursor blink.

In related art, the control of a cursor to edit or correct a character may be implemented by directly selecting (touching, tapping) the location of the corresponding character by the user in an area in which the input character is displayed to move the cursor, or by moving (dragging) the cursor to the location of the corresponding character after directly selecting (touching, tapping) the cursor by the user in an area in which the input character is displayed. In the related art, since the displayed size of the cursor is restrictive, it is difficult to intuitively recognize the location of the cursor, and the usability may be reduced due to a difficulty of the selection and movement of the cursor.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and an electronic apparatus for operating a cursor handle for enhancing an ease of cursor control in a character input mode.

The electronic apparatus of the present disclosure may include all information communication devices supporting a function according to various embodiments of the present disclosure, multimedia devices, wearable devices and application devices thereof such as all devices using one or more of an Application Processor (AP), Graphic Processing Unit (GPU), and a Central Processing Unit (CPU).

Another aspect of the present disclosure is to provide a method and an electronic apparatus capable of automatically changing a state of a cursor handle according to a state of user input in a text input mode.

Another aspect of the present disclosure is to provide a method and an electronic apparatus capable of enhancing a visual effect and a usability by changing a cursor handle according to a state of user input.

Another aspect of the present disclosure is to provide a method and an electronic apparatus capable of displaying a cursor handle according to a state of user input or removing the displayed cursor, and differently supporting a shape (a size, a form, a color, etc.) of a cursor handle according to a state of user input when displaying the cursor handle.

Another aspect of the present disclosure is to provide a method and an electronic apparatus capable of removing a displayed cursor during an operation of character input by a user in a character input mode, and displaying the cursor handle when the operation of character input is completed.

Another aspect of the present disclosure is to provide a method and an electronic apparatus capable of automatically changing and displaying a size of a cursor handle in response to a user input during an operation of a user's cursor control in a character input mode.

Another aspect of the present disclosure is to provide a method and an electronic apparatus capable of enhancing user's ease, a visibility, and a usability of electronic device by implementing an optimal environment for operating an input function by using a cursor in an electronic device.

In accordance with an aspect of the present disclosure, a method of supporting an input function of an electronic device is provided. The method includes executing, by the electronic device, a character input mode, providing a cursor handle to support an input function in the character input mode, and changing the cursor handle in response to a user input.

In accordance with another aspect of the present disclosure, a method of supporting an input function of an electronic device is provided. The method includes displaying, by the electronic device, a cursor handle in a character input mode, detecting a user event, controlling a change corresponding to a display or a removal of the cursor handle in response to the user event, when the user event is an event for inputting a character, and controlling a change of at least one of a size, a shape, and a color of the cursor handle in response to the user event, when the user event is an event for cursor control.

In accordance with another aspect of the present disclosure, an electronic device is provided. The device includes a display unit configured to display a screen according to a character input mode and a cursor handle for supporting an input function, a touch sensing unit configured to receive a user input for a character input and a cursor control in the character input mode, and a controller configured to control a change of the cursor handle in response to the user input in the character input mode.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating a schematic configuration of an electronic device according to an embodiment of the present disclosure;

FIG. 2 is a flowchart illustrating a method of operating a cursor handle for supporting an input function in an electronic device according to an embodiment of the present disclosure;

FIGS. 3A, 3B and 3C are diagrams illustrating examples of a cursor handle supported in an electronic device according to various embodiments of the present disclosure;

FIG. 4 is a diagram illustrating an operation of providing a cursor handle in an electronic device according to an embodiment of the present disclosure;

FIG. 5 is a diagram illustrating an operation of providing a cursor handle in an electronic device according to an embodiment of the present disclosure;

FIG. 6 is a flowchart illustrating a method of operating a cursor handle in an electronic device according to an embodiment of the present disclosure; and

FIG. 7 is a flowchart illustrating a method of operating a cursor handle in an electronic device according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The present disclosure is related to a method and an electronic apparatus for supporting a cursor handle in response to a user input using various input means (e.g., a user hand, a stylus, etc.). A cursor according to an embodiment of the present disclosure may represent a mark indicating a location displaying a character (e.g., a letter, a number, a figure, etc.) on a character input mode screen of an electronic device. For example, a character inputted through a keypad by a user may be displayed at a location of a cursor on a screen, and simultaneously, the cursor may be moved to the right one by one. In general, the cursor blinks to indicate that character can be inputted, which is referred to as a cursor blink. In the embodiment of the present disclosure, a cursor handle (or a handle) may include an auxiliary handle for a cursor related (e.g., a connected or set area) to the cursor so as to effectively control the cursor.

In the embodiment of the present disclosure, the user input relating to an operation of the cursor handle may include an input approaching (drawing near) on an area in which the cursor is located (e.g., hovering), or an input directly contacting with an area in which the cursor is located (e.g., a touch-based input (e.g., a touch, a tap)) by various input means. For example, in the embodiments of the present disclosure, the user input relating to an operation of the cursor handle may include a hovering-based input which is inputted from a space over the touch screen without a direct contact with the touch screen, and all types of hand gesture-based input that can be recognized by various sensors, as well as a touch-based input.

In the embodiment of the present disclosure, the touch-based input may include a touch, a tap, a double tap, a drag, a sweep, a flick, a drag-and-drop, and the like, and the various sensors may include a voice recognition sensor, a gyro sensor, a geomagnetic sensor, an acceleration sensor, an image sensor, a motion sensor, an infrared sensor, an illumination sensor, and the like. In addition, the hand gesture based input may include a posture change of a user's hand (or a specific object replacing user's hand) being detected through at least one sensor being operated in a state of execution of character input mode or the electronic device detected through at least one sensor, and the like. That is, in the embodiment of the present disclosure, the user input may include all types of interactions inputted by the user.

In the embodiment of the present disclosure, an input state of approaching (drawing near) on a screen (e.g., an area displaying a cursor handle) by the input means is referred to as an air view state, and an input state of contacting to the screen (e.g., an area displaying a cursor handle) by the input means is referred to as a contact state. According to the embodiment of the present disclosure, the cursor handle may be automatically changed according to the user input state. For example, in the embodiment of the present disclosure, when the user input is detected in the character input mode, the display or removal of the handle may be implemented by toggling and/or changing the shape (e.g., a size, a figure, a color, etc.) of the cursor handle in response to the user input.

Hereinafter, a method and an apparatus for operating an electronic apparatus according to an embodiment of the present disclosure are described with reference to the accompanying drawings in detail. Detailed descriptions of well-known functions and structures incorporated herein may be omitted to avoid obscuring the subject matter of the present disclosure. The embodiments and the configurations depicted in the drawings are illustrative purposes only and do not represent all technical scopes of the embodiments, so it should be understood that various equivalents and modifications may exist at the time of filing this application.

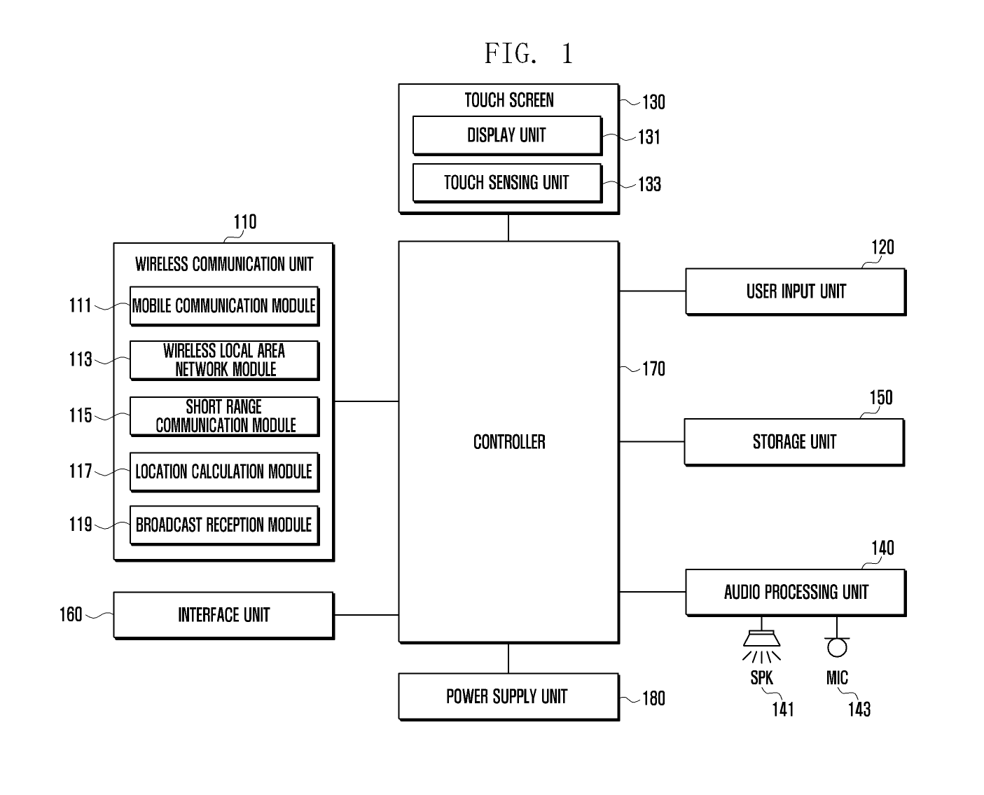

FIGS. 1 through 7, discussed below, and the various embodiments used to describe the principles of the present disclosure in this patent document are by way of illustration only and should not be construed in any way that would limit the scope of the disclosure. Those skilled in the art will understand that the principles of the present disclosure may be implemented in any suitably arranged communications system. The terms used to describe various embodiments are exemplary. It should be understood that these are provided to merely aid the understanding of the description, and that their use and definitions in no way limit the scope of the present disclosure. Terms first, second, and the like are used to differentiate between objects having the same terminology and are in no way intended to represent a chronological order, unless where explicitly stated otherwise. A set is defined as a non-empty set including at least one element.

FIG. 1 is a block diagram illustrating a schematic configuration of an electronic device according to an embodiment of the present disclosure.

Referring to FIG. 1, an electronic device of the present disclosure, which may include a wireless communication unit 110, a user input unit 120, a touch screen 130, an audio processing unit 140, a storage unit 150, an interface unit 160, a controller 170, and a power supply unit 180, is illustrated. Since each of the elements illustrated in FIG. 1 are not essential, the electronic device of an embodiment of the present disclosure may be implemented by more elements or fewer elements than the elements illustrated in FIG. 1. For example, when the electronic device according to an embodiment of the present disclosure supports a photographing function, a camera module may be further included. In addition, when the electronic device according to an embodiment of the present disclosure does not support a broadcast reception and play function, the configuration of some modules (e.g., a broadcast reception module 119 of the wireless communication unit 110) may be omitted.

The wireless communication unit 110 may include one or more modules that enable a wireless communication between the electronic device and a wireless communication system or between the electronic device and other electronic device. For example, the wireless communication unit 110 may include a mobile communication module 111, a Wireless Local Area Network (WLAN) module 113, a short range communication module 115, a location calculation module 117, and a broadcast reception module 119, and the like.

The mobile communication module 111 may transmit and receive a wireless signal with at least one of a base station, an external terminal, and various servers (e.g., an integration server, a provider server, a content server, an internet server, a cloud server, etc.) on a mobile communication network. The wireless signal may include a voice call signal, a video call signal, or various types of data according to the transmission and reception of text/multimedia message. The mobile communication module 111 may receive various types of cursor handles that can be provided in the character input mode from the outside (an external terminal or server).

The WLAN module 113 indicates a module to form a wireless Internet access and a WLAN link with other electronic device, and may be built in the electronic device or implemented in the outside of the electronic device. A wireless Internet technology may use a Wi-Fi, a Wireless broadband (Wibro), a World Interoperability for Microwave Access (Wimax), a High Speed Downlink Packet Access (HSDPA), and the like. The WLAN module 113 may transmit data inputted from the user through a messenger, or may receive data from the outside. In addition, the WLAN module 113 may receive various cursor handles supported by the electronic device from the outside according to a user request. In addition, the WLAN module 113 may transmit or receive various data (e.g., an image, a video, a music, a cursor handle, etc.) according to a user selection to/from other electronic device when forming a WLAN link with another device. The WLAN module 113 may constantly maintain a turned-on state, or may be turned on according to a user setting or an input.

The short range communication module 115 may include a module for a short range communication. The short-range communication technology may use a Bluetooth, a Bluetooth Low Energy (BLE), a Radio Frequency Identification (RFID), an Infrared Data Association (IrDA,), a Ultra Wideband (UWB), a ZigBee, a Near Field Communication (NFC), and the like. In addition, the short-range communication module 115 may transmit and receive data (e.g., images, videos, music, cursor handle, etc.) according to a user selection to/from other electronic device when a short-range communication is connected to other electronic device. The short range communication module 115 may constantly maintain a turned-on state, or may be turned on according to a user setting or an input.

The location calculation module 117 is a module for obtaining a location of the electronic device, and may include, as a typical example, a Global Position System (GPS) module. The location calculation module 117 may calculate distance information located from three or more base stations and accurate time information, and apply trigonometry to the calculated information, so that three-dimensional current location information according to a latitude, a longitude, and an altitude may be calculated. Alternatively, the location calculation module 117 may calculate location information by continuously receiving location information of the electronic device in real time from three or more satellites. The position information of the electronic device may be obtained by various methods.

The broadcast reception module 119 may receive a broadcast signal (e.g., TV broadcast signal, a radio broadcast signal, a data broadcast signal, etc.) and/or information related to the broadcast (e.g., information relating to a broadcast channel, a broadcast program or a broadcast service provider, etc.) from an external broadcast management server through a broadcast channel (e.g., a satellite broadcast channel, a terrestrial broadcast channel, etc.).

The user input unit 120 may generate input data for controlling the operation of the electronic device in response to the user input. The user input 120 may include a keypad, a dome switch, a touchpad (resistive/capacitive), a jog wheel, a jog switch, a sensor (e.g., a voice recognition sensor, a proximity sensor, an illumination sensor, an acceleration sensor, a gyro sensor, etc.), and the like. In addition, the user input unit 120 may be implemented in the form of a button in the outside of the electronic device, and some buttons may be implemented as a touch panel. The user input unit 120 may receive a user input for starting the operation of the input function by the cursor handle according to an embodiment of the present disclosure and may generate a corresponding input signal.

The touch screen 130 is an input and output means to perform an input function and a display function simultaneously, and may include a display unit 131 and a touch sensing unit 133. The touch screen 130 may display various screens (e.g., a messenger screen, a screen for call origination, a game screen, a gallery screen, a message screen, etc.) according to the operation of the electronic device through the display unit 131. The touch screen 130 may transmit an input signal according to a user event to the controller 170, when the user event (e.g., a touch event, a hovering event) is inputted while displaying the screen through the display unit 131. Then, the controller 170 may distinguish the user event, and may control an operation according to the user event.

The display unit 131 may display (output) information processed by the electronic device. For example, when the electronic device is a communication mode, the display unit 131 may display a User Interface (UI) or a Graphical User Interface (GUI) related to a call. In addition, the display unit 131 may display a photographed or/and received image a UI, or a GUI when the electronic device is a video call mode or a photographing mode. In an embodiment of the present disclosure, the display unit 131 may display an execution screen of various applications supporting the character input mode. The display unit 131 may display a cursor handle guiding the character input of the user in the character input mode. When the cursor handle is provided through the display unit 131, it may be blinked to notify that characters can be inputted.

The cursor handle may be toggled (e.g., display or remove a cursor handle) in the display unit 131 in response to a user input. The display unit 131 may display the cursor handle which is changed in a form corresponding to the user input in the text input mode. In addition, according to a rotation direction (orientation) of the electronic device, the display unit 131 may support a screen display in a landscape mode, a screen display in a portrait mode, and a screen change display according to a change between a landscape mode and a portrait mode. An example of screen of the display unit 131 operated in the embodiment of the present disclosure will be described later.

The display unit 131 may include at least one of a Liquid Crystal Display (LCD), a Thin Film Transistor LCD (TFT LCD), a Light Emitting Diode (LED), an Organic LED (OLED), an Active Matrix OLED (AMOLED), a flexible display, a bended display, or a 3D display. Some of these displays may be implemented as transparent display which is configured by a transparent type or an optical transparent type which enables to see the outside.

The touch sensing unit 133 may be placed on the display unit 131, and may sense (detect) user's touch event (e.g., a tap, a drag, a sweep, a flick, a drag and drop, a drawing, a long press, a single touch, a multi-touch, a touch-based gesture (e.g., handwriting, etc.) which contacts a surface of the touch screen 130. The touch sensing unit 133 may detect a coordinate in which a touch event is generated when sensing the touch event of the user on the surface of the touch screen 130, and may transmit the detected coordinate to the controller 170. The touch sensing unit 133 may sense (detect) the touch event generated by the user, and generate a signal according to the sensed touch event to transmit to the controller 170. The controller 170 may control a function operation corresponding to an area in which the touch event is generated by the signal transmitted from the touch sensing unit 133.

In addition, the touch sensing unit 133 may sense (detect) a hovering event by an input means (e.g., user's finger, stylus, etc.) which enters within a certain distance from the surface of the touch screen 130 and is maintained at a certain height, and generate a signal according to the detected hovering event to transmit to the controller 170. The touch sensing unit 133 may measure an amount of current in a certain distance even though the input means is not contacted to the surface of the touch screen 130, and may sense (detect) the recognition, the move, the release of the input means. The controller 170 may analyze the hovering event by the signal transmitted from the touch sensing unit 133, and may control the function operation corresponding to the analyzed hovering event. The touch sensing unit 133 may receive the user input to control the cursor handle in a state in which the screen is displayed through the display unit 131, and may generate a corresponding input signal.

The touch sensing unit 133 may be configured to convert a change of a pressure applied to a specific part of the display unit 131 or a capacitance generated in a specific part of the display unit 131 to an electrical input signal. The touch sensing unit 133 may be configured to detect a pressure at the time of touching according to an applied touch type as well as a touched location and area. When a touch input is entered on the touch sensing unit 133, a corresponding signal(s) may be transmitted to a touch controller (not shown). The touch controller (not shown) may process the signal(s) and transmit a corresponding data to the controller 170. Thus, the controller 170 may recognize the touched area of the touch screen 130.

The audio processing unit 140 may transmit an audio signal input from the controller 170 to a speaker (SPK) 141, and transmit the audio signal such as a voice inputted from a microphone (MIC) 143 to the controller 170. The audio processing unit 140 may convert a voice/sound data into an audible sound to output through a speaker 141 and convert an audio signal such as a voice received from a microphone 143 into a digital signal to transmit to the controller 170 under the control of the controller 170.

The speaker 141 may output an audio data received from the wireless communication unit 110, or stored in the storage unit 150 in a messenger mode, a call mode, a message mode, a recording sound (video) mode, a voice recognition mode, a broadcast reception mode, and a media content (a music file, a video file) play mode, etc. The speaker 141 may output a sound signal related to a function (e.g., a messenger execution, a conversation reception, a conversation transmission, a content image display, a content image related function execution, a call connection reception, a call connection transmission, a recording, a media content file play, etc.) performed in the electronic device.

The microphone 143 may receive an external sound signal to process as an electrical voice data in a messenger mode, a call mode, a message mode, a recording sound (video) mode, and a voice recognition mode. In the call mode, the processed voice data may be converted into a form transmittable to a mobile communication base station through the mobile communication module 111. Various noise remove algorithms to remove a noise generated in a process of receiving an external sound signal may be implemented in the microphone 143.

The storage unit 150 may store a program for the process and control of the controller 170, and may perform a temporary storage of input/output data (e.g., a shared object, a messenger data, a content image, a contact information, a message, a media content (e.g., audio, video, image), and the like). The storage unit 150 may store a frequency of use (e.g., frequency of application, frequency of input character, frequency of content, etc.) according to function operation of the electronic device, an importance, and a priority. The storage unit 150 may store a vibration and a sound of various patterns outputted in response to a touch input on the touch screen 130. The storage unit 150 may store a cursor handle, and a provided type (e.g., a form, a blink, etc.) of the cursor handle.

The storage 150 may continuously or temporarily store an Operating System (OS) of the electronic device, a program related to an input and display of control operation using the touch screen 130, a program and a data related to an input function control operation by the input handle in the character input mode, and a data generated by an operation of each program.

The storage unit 150 may include at least one type of storage medium among a flash memory type, a hard disk type, a micro type, a card type (e.g., a Secure Digital Card (SD Card) or an eXtreme Digital Card (XD Card)), a Dynamic Random Access Memory (DRAM), a Static RAM (SRAM), a Read-Only Memory (ROM), a Programmable ROM (PROM), an Electrically Erasable PROM (EEPROM), a Magnetic RAM (MRAM), a magnetic disk, and an optical disk. The electronic device may be operated in relation to a web storage performing a storage function of the storage unit 150.

The interface unit 160 may serve as a path for all external devices connected to the electronic device. The interface unit 160 may receive a data or be provided a power from the external device to transmit to each element inside of the electronic device, or may transmit data inside of the electronic device to transmit to the external device. For example, the interface unit 160 may include a wired/wireless headset port, an external charger port, a wired/wireless data port, a memory card port, a port connecting a device equipped with an identification module, an audio input/output port, a video input/output port, and an earphone port, and the like.

The controller 170 may control the overall operation of the electronic device. For example, the controller 170 may perform a control related to a voice communication, a data communication, a video communication, or the like. The controller 170 may process an operation related to a function that automatically changes the cursor handle in response to a user input in the character input screen, and may include a data processing module (not shown) that can process such an operation.

In an embodiment of the present disclosure, the controller 170 may control to remove (dissipate) a display of the cursor handle displayed on the display unit in response to the user input for inputting the character, and to display the cursor handle in a corresponding location according to the character input when a user input for inputting the character is completed (released). The controller 170 may control to differently display a shape (e.g., a size, a figure, a color, etc.) of the cursor handle in response to the user input for the control (e.g., a movement of the cursor handle for an editing of the inputted character) of the cursor handle.

A detailed control operation of the controller 170 will be described later with reference to the drawings for the operation of the electronic device and its control method.

The controller 170 according to an embodiment of the disclosure may control various operations related to a function of electronic device in addition to the above mentioned function. For example, when executing a specific application, the controller 170 may control the operation of the application and the display of screen. In addition, the controller 170 may receive an input signal corresponding to various touch event (or a hovering event) inputs supported by a touch-based input interface (e.g., touch screen 130) to control a corresponding function operation. In addition, the controller 170 may control the transmission and reception of various data based on a wired communication or a wireless communication.

The power supply unit 180 may receive an external power and an internal power to supply a power necessary for an operation of each element under the control of the controller 170.

As described above, an electronic device according to various embodiments of the present disclosure may include all the information communication devices that supports the function of the present disclosure, a multimedia device, and application device thereof, such as all devices that uses an Application Processor (AP), a GPU, and a CPU. For example, the electronic device may include a tablet PC, a Smart Phone, a wearable device (e.g., including all IT (or smart) devices that user can wear or put on such as a wearable phone, a wearable watch, a wearable computer, a wearable camera, a wearable shoes, a wearable pendant, a wearable ring, a wearable bracelet, a wearable glasses (goggles), etc.), a Portable Multimedia Player (PMP), a Media Player (e.g., a MP3 player), a mobile game terminal, and a PDA, in addition to a mobile communication terminal operated based on respective communication protocols corresponding to various communication systems. Further, a method of controlling a function according to various embodiments of the present disclosure may be applied to a laptop computer (e.g., a notebook computer), a PC, or various display devices such as a Digital Television (TV), a Digital Signage (DS), a Large Format Display (LFD), etc.

Various embodiments described in the present disclosure may be implemented within a recording medium readable by a computer or a device similar to the computer by using a software, a hardware, or a combination thereof. In terms of a hardware implementation, the embodiments described in the present disclosure may be implemented by using at least one of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, or electrical units for performing other function.

In an embodiment of the present disclosure, the recording medium may be a non-transitory computer-readable recording medium having a program recorded thereon for performing an operation of executing a character input mode, an operation of providing a cursor handle supporting an input function in the character input mode, and an operation of change the cursor handle in response to a user input. In an embodiment of the present disclosure, the recording medium may include a recording medium readable by a computer storing a program performing an operation of displaying a cursor handle in a character input mode, an operation of detecting a user event, an operation of controlling a change corresponding to a display or a removal of the cursor handle in response to a user event when the user event is an event for inputting a character, and an operation of controlling a change of at least one of a size, a form, or a color of the cursor handle in response to a user event when the user event is an event for controlling a cursor.

In some cases, the embodiments described herein may be implemented in the controller 170 itself In addition, in terms of a software implementation, the embodiments of procedures and functions described herein may be implemented by separate software modules. Each of the software modules may perform one or more functions and operations described herein.

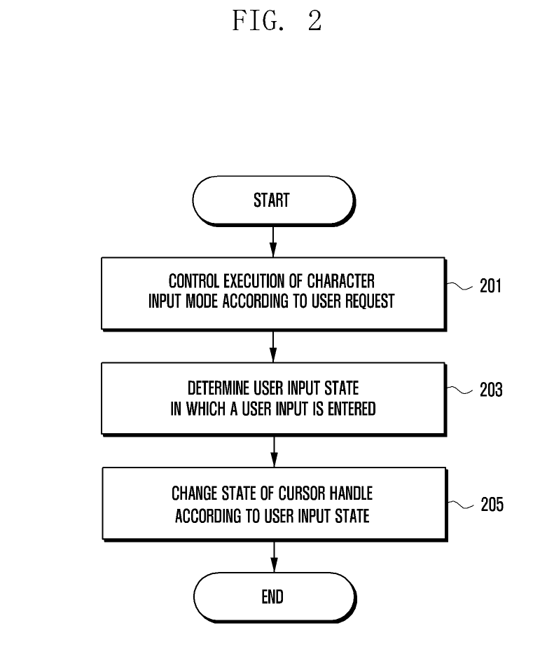

FIG. 2 is a flowchart illustrating a method of operating a cursor handle for supporting an input function in an electronic device according to an embodiment of the present disclosure.

Referring to FIG. 2, a method, in which a controller 170 may control an execution of a character input mode according to a user request at operation 201, is illustrated. For example, the controller 170 may control a screen display of the character input mode implemented by a UI or a GUI corresponding to a messenger in response to an execution request of instant messenger application of a user, and may control a screen display of the character input mode implemented by a UI or a GUI corresponding to a mail in response to an execution request of mail application of the user.

The controller 170 may determine the state in which a user input is entered when the user input is detected in the character input mode at operation 203. For example, the controller 170 may determine the user input state whether the user input is an event for inputting a character, an event for controlling a cursor handle, an air view state in a location in which the cursor handle is positioned, or a contact state.

The controller 70 may change and provide the state of the cursor handle according to the state of the user input at operation 205. For example, when the user input is determined as an event (e.g., a user input inputting a character by using a keyboard or a keypad) for inputting a character in a state in which the cursor handle is displayed in the character input mode, the controller 170 may operate to remove (dissipate) a display of the cursor handle being displayed.

When the user input is determined as a release event (e.g., completion of character input) to release a character input in the character input mode, the controller 170 may operate to display the cursor handle in a location in which the character is inputted. When the user input is determined as an event according to an air view state or a contact state in a location in which the cursor handle is inputted in the character input mode, the controller 170 may operate to change the shape (e.g., a form, a size, a color, etc.) of the cursor handle.

As described above, according to an embodiment of the present disclosure, the user may input a character in various character input modes (e.g., a character input state in a function such as a message, an email, a messenger, a web page, and a search) of the electronic device, or may edit (e.g., deletion, modification, addition) all or part of the inputted characters. The user may input a character by using a handwriting or a keypad in the character input mode. In an embodiment of the present disclosure, in the text input mode, the cursor handle is disappeared (e.g., a cursor handle is dissipated on a screen) during when the user inputs a character in the character input mode, and the cursor handle may be provided again at the end of the operation of the character input.

In the embodiment of the present disclosure, when the user selects (e.g., a selection according to an air view state or a contact state) the cursor handle for an edition of the character in the character input mode, the shape (e.g., a size, a form, a color, etc.) of the cursor handle may be differently changed and provided. For example, the controller 170 may largely provide a default size (e.g., size 1) of the cursor handle as a size of a preset ratio or a random ratio (e.g., size 2) (here, size 1<size 2).

Alternatively, the controller 170 may provide the default form (e.g., form 1) of the cursor handle as a preset different form (e.g., form 2) or a random form. Alternatively, the controller 170 may provide the default color (e.g., color 1) of the cursor handle as a preset different color (e.g., color 2) or a random color. Alternatively, the controller 170 may provide the default shape (e.g., size 1, form 1, color 1) of the cursor handle as a preset different shape (e.g., at least one of size 2, form 2, color 2) or a random shape.

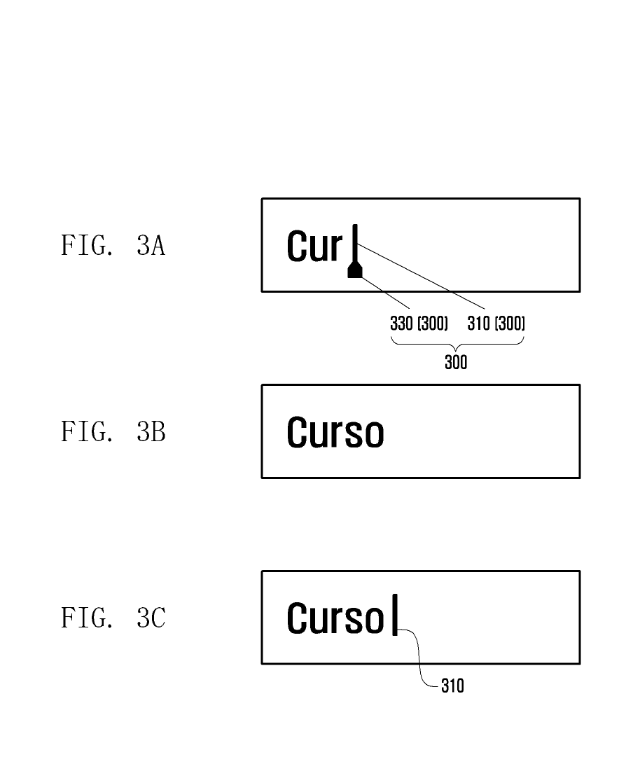

FIGS. 3A, 3B and 3C are diagrams illustrating examples of a cursor handle supported in an electronic device according to various embodiments of the present disclosure.

Referring to FIG. 3A, a cursor handle on a screen in a character input mode, and an example of a screen of the electronic device waiting an input from a user are illustrated. Referring to FIGS. 3B and 3C, examples of a screen of the electronic device when the user inputs a character in the character input mode are illustrated.

As illustrated in FIG. 3A, the cursor handle 300 may be divided into a cursor 310 and a handle 330. In an embodiment of the present disclosure, the cursor handle 300 may operate the cursor 310 and the handle 330 as a single item, or separate the cursor 310 and the handle 330 to operate as discrete items. For example, FIG. 3B illustrates an operation that operates the cursor handle 300 as a single item, where the cursor handle 300 itself is generated or removed (dissipated) in response to the user input. In addition, FIG. 3C illustrates an operation that operates the cursor handle 300 as a discrete item, and shows that the handle 330 is generated or removed (dissipated) from the cursor handle 300 in response to the user input.

As illustrated in FIG. 3A, in the present disclosure, when waiting for a user input or when a user input is terminated (release of a user input), the cursor handle 300 may be displayed. At this time, the cursor handle 300 (particularly, handle 330) may be provided in various forms by the user according to a preset shape (form, size, color).

As shown in FIG. 3B, in the present disclosure, the cursor handle 300 may be removed (dissipated) at the point of time when a user starts (begins) a character input by using a keypad or a handwriting. Alternatively, as shown in FIG. 3C, in the present disclosure, at the point of time when the user starts a character input, only the handle 330 of the cursor handle 300 may be removed and the cursor 310 may be continuously provided.

In the state of FIG. 3B, when the character input of the user is completed (release of the user input), the cursor handle 300 may be generated in a location in which a last character (e.g., “o”) according to the user input is inputted. Alternatively, in the state of FIG. 3C, when the character input of the user is completed (release of the user input), the handle 330 may be generated in the cursor 310 which is moved according to the character input due to the user input to provide the cursor handle 300.

In the meantime, as shown in FIGS. 3A, 3B and 3C, various embodiments of the present disclosure illustrate that the cursor handle 300 is provided when there is no user input, and the cursor handle 300 is not provided when there is a user input. Furthermore, the embodiment of the present disclosure may be operated in such a manner that the cursor handle 300 is not provided when there is no user input, and, when the user input enters in the vicinity of the region where a keypad or the cursor handle 300 is provided, the cursor handle 300 is generated in a corresponding location by recognizing the entrance of the user input.

According to an embodiment of the disclosure, the user may previously set an operation method for the cursor handle 300, display the cursor handle 300 when executing the character input mode according to a setting method of the user, or omit the cursor handle 300. Therefore, according to the embodiment of the present disclosure, in a case of providing the cursor handle 300 in the character input mode, the cursor handle 300 may be removed (dissipated) in response to the user input, and the cursor handle 300 may be displayed in response to the release of the user input.

According to the embodiment of the present disclosure, in a case of omitting the cursor handle 300 in the character input mode, the cursor handle 300 may be displayed in response to the user input, and the cursor handle 300 may be removed (dissipated) in response to the release of the user input.

Further, FIGS. 3A, 3B and 3C illustrate examples of the cursor handle 300 that can be provided in the present disclosure, and the shape (form, size, color, etc.) of the cursor handle 300 may be variously implemented. For example, the cursor handle 300 may be implemented in various shapes such as a circle, a triangle, a rectangle, a hexagon, an inverted triangle, oval, star, etc. as well as a pentagonal shape. In addition, the handle 330 of the cursor handle 300 may be implemented by not only a single color but also a combination of different colors (e.g., a combination of at least two colors). In addition, the cursor handle 300 may be implemented by various structures including a structure in which the handle 330 may be connected to a middle of the cursor 310 or an upper end point of the cursor 310 in addition to a structure in which the handle 330 may be connected to a lower end point of the cursor 310.

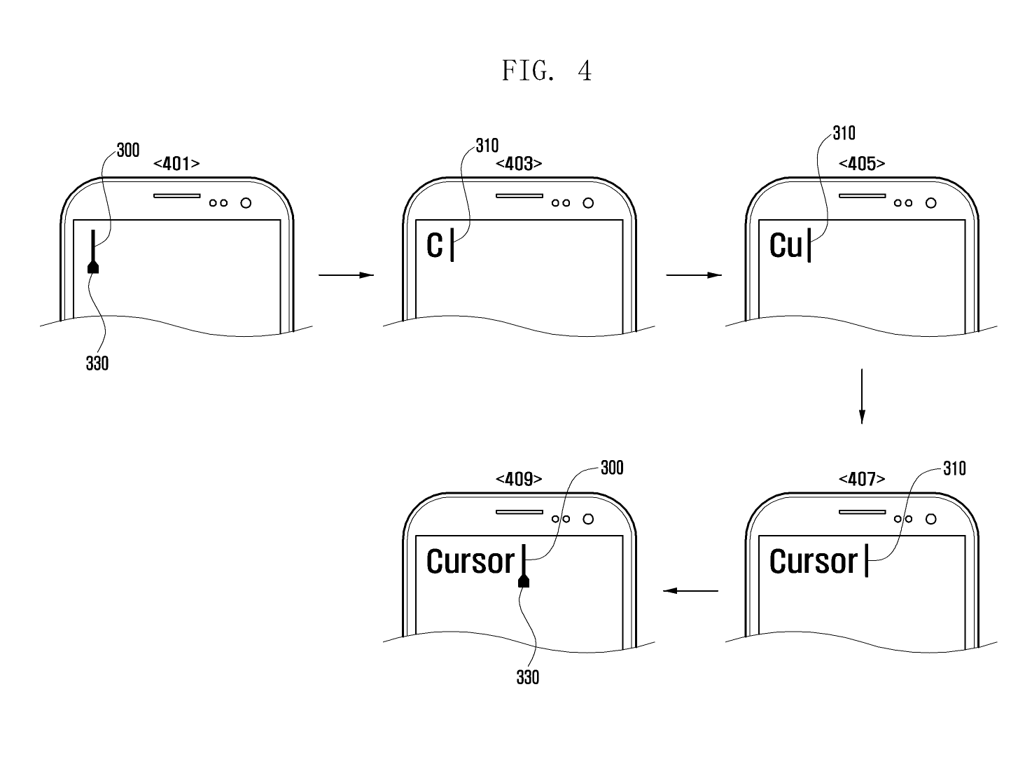

FIG. 4 is a diagram illustrating an operation of providing a cursor handle in an electronic device according to an embodiment of the present disclosure.

Referring to FIG. 4, <401> illustrates a screen of an electronic device when user executes a character input mode to wait for a character input. As shown in <401>, the cursor handle 300 may be provided to an area in which a character corresponding to a user input is outputted (displayed) in the character input mode, and the cursor handle 300 may be provided in a blink method according to a setting method.

In a state of <401>, as shown in <403> to <407>, the user may input characters (e.g., “Cursor”) sequentially through a handwriting or a keypad using an input means. As shown in <403> to <407>, the display of the cursor handle 300 or the handle 330 may be omitted till a completion of the character input from the start of the character input by the user. That is, the cursor handle 300 may be removed (dissipated) from the screen.

The embodiment of FIG. 4 illustrates that the handle 330 of the cursor handle 300 is changed in response to the user input, and thus the display of the cursor 310 of the cursor handle 300 may be maintained regardless of the user input. However, since the present disclosure is not limited thereto, it may change (e.g., display or remove) the cursor handle 300 itself in response to the user input.

Further, when the character input by the user is completed as shown in <407>, the cursor handle 300 may be generated and displayed as shown in <409>. For example, as shown in <407>, the handle 330 may be generated to be displayed again along with the cursor 310 of the cursor handle 300. At this time, the location of the cursor handle 300 may be moved to a location in which the last character (e.g., “r”) is input in response to the input of character (e.g., Cursor) by the user.

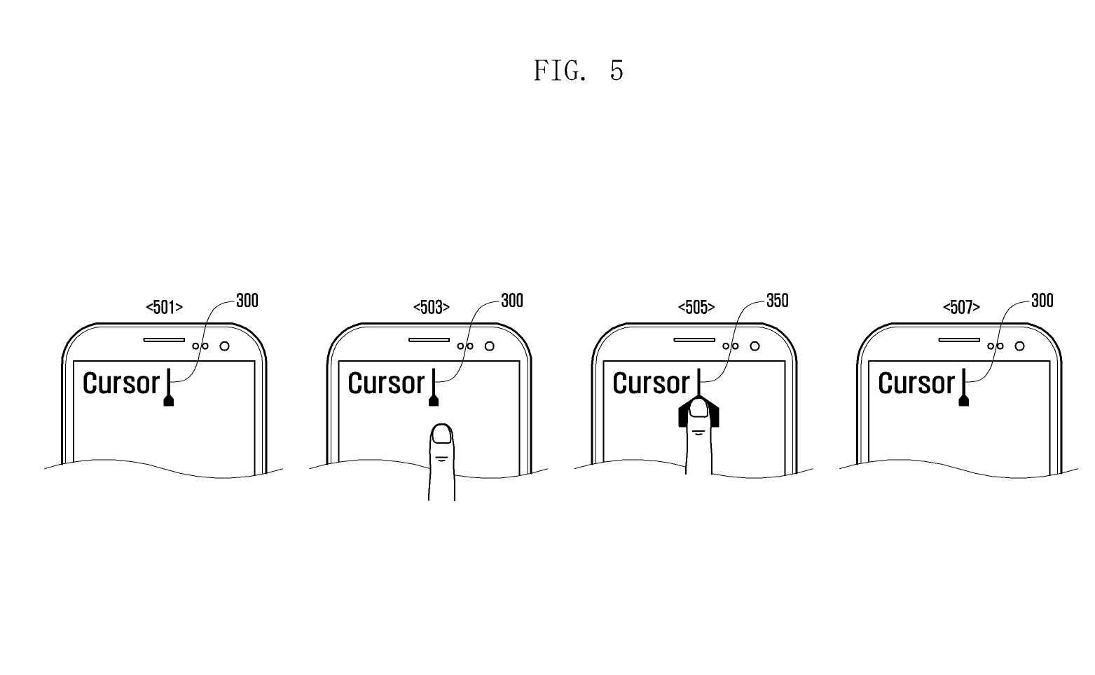

FIG. 5 is a diagram illustrating an operation of providing a cursor handle in an electronic device according to an embodiment of the present disclosure.

Referring to FIG. 5, <501> illustrates a screen of an electronic device when a user executes a character input mode to wait for a next operation after inputting specific characters (e.g., “Cursor”). As shown in <501>, the cursor handle 300 of default shape may be provided to an area in which a character corresponding to a user input is outputted (displayed) in the character input mode, and the cursor handle 300 may be in a blink state according to a setting method.

In the state of <501>, the user may select to move the input means close to the area displaying the cursor handle 300 as an air view state or a contact state as shown in <503>. For example, the user may input a hovering event on the cursor handle 300, or may input a touch event to the cursor handle 300 in order to operate (e.g., move) the cursor handle 300 for an edition of the input characters (e.g., “Cursor”).

The electronic device may change the shape (e.g., size) of the cursor handle 300 supplied as a default shape into the shape of the cursor handle 350 as shown in <505> in response to the user input as shown in <503>. For example, assuming that the cursor handle 300 of the default shape has size 1, the changed cursor handle 350 may have size 2 which is greater than size 1. Alternatively, assuming that the cursor handle 300 of the default shape has form 1 (e.g., a pentagon), the changed cursor handle 350 may have form 2 (e.g., a star shape). Alternatively, assuming that the cursor handle 300 of the default shape has color 1 (e.g., blue color), the changed cursor handle 350 may have color 2 (e.g., red, rainbow color, etc.). Alternatively, assuming that the cursor handle 300 of the default shape has size 1, form 1, and color 1, the changed cursor handle 350 may have at least one of size 1, form 1, and color 2. In an embodiment of the present disclosure, it is illustrated that the change of the cursor handle 300 is implemented by changing only the handle 330 of the cursor handle 300, but the present disclosure is not limited thereto, and the shape (form, size (e.g., thickness), color) of the cursor 310 may also be changed.

As shown in <505>, if the cursor handle 350 is changed, the user may recognize that the cursor handle 350 is able to be operated, and may operate (e.g., move) the cursor handle 350 according to a desire of the user. In the embodiment of the present disclosure, when the user input for the operation of the cursor handle 350 is maintained, the changed shape of the cursor handle 350 may be maintained.

In the state of <505>, the user may release the user input for the operation of the cursor handle 350. For example, the user may release the hovering event inputted in the cursor handle 350 or the touch event. The electronic device may change the changed cursor handle 350 to the cursor handle 300 of the default shape as shown in <507> in response to the release of the user input for the changed cursor handle 350.

As described above, the embodiment of the present disclosure may vary the shape (at least one of form, size, and color) of the cursor handle 300. Therefore, according to the embodiment of the present disclosure, visibility and operability of the user for operation of the cursor handle may be improved.

As mentioned in the above with reference to FIGS. 4 and 5, according to various embodiments of the present disclosure, when providing the character input mode, the cursor handle 300 of default shape (e.g., size, form, color) may be provided. When the user input for the character input is sensed (detected) by the touch sensing unit 133 in the state in which the cursor handle 300 of default shape is provided, the cursor handle 300 of default shape (size, form, color) may be removed from the screen in response to the user input. Next, when the release of the user input is sensed (detected) by the touch sensing unit 133, the cursor handle 300 of default shape may be displayed on the screen in response to the release of the user input. Further, when the access of the user input for controlling the cursor is detected by the touch sensing unit 133, the cursor handle 300 of default shape may be changed and displayed.

For example, the cursor handle 350 having a second size which is greater than a first size may be provided according to the access of the user input for controlling the cursor. Alternatively, the cursor handle having a second form which is different from a first form may be provided according to the access of the user input. Alternatively, the cursor handle having a second color which is different from a first color may be provided according to the access of the user input. Alternatively, at least one of a form, a size, or a color from a first shape (e.g., form 1, size 1, and color 1) of the cursor handle is changed or at least two are changed and provided.

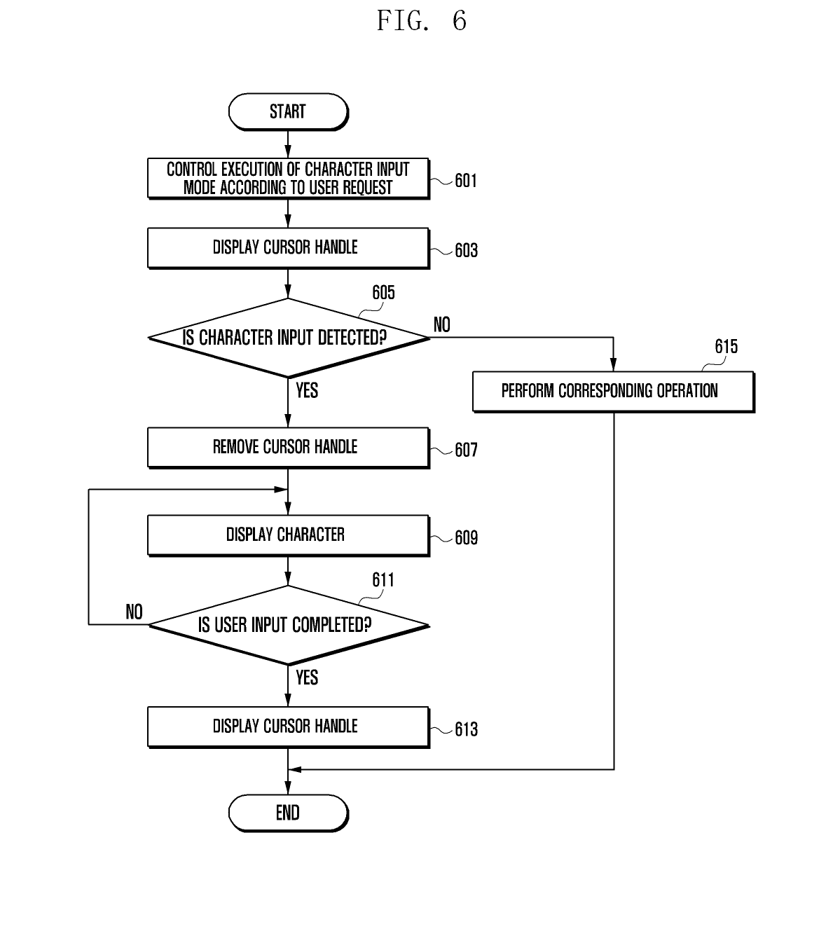

FIG. 6 is a flowchart illustrating a method of operating a cursor handle in an electronic device according to an embodiment of the present disclosure.

Referring to FIG. 6, a method where a controller 170 may control to execute a character input mode according to a request of a user at operation 601 is illustrated. For example, the controller 170 may control the screen display of the character input mode implemented by the UI or the GUI corresponding to a messenger in response to the execution request of the messenger application of the user, and may control the screen display of the character input mode implemented by the UI or the GUI corresponding to e-mail in response to the execution request of the e-mail application of the user.

The controller 170 may control to display a cursor handle when executing the character input mode at operation 603. The controller 170 may provide the cursor handle of a preset default shape (form, size, color). The controller 170 may determine whether a user input for inputting a character is detected at operation 605.

The controller 170 may control to perform a corresponding operation at operation 615 when the user input for inputting a character is not detected (NO of operation 605). For example, the controller 170 may process to wait the user input for the input of character, to terminate the character input mode in response to a user request, or to change the cursor handle in response to the user input for the control of the cursor handle.

When the user input for inputting a character is detected (YES of operation 605), the cursor handle may be removed (dissipated) from the screen corresponding to the character input mode at operation 607, and may control to display the character corresponding to the user input at operation 609.

The controller 170 may determine whether the user input for inputting a character is released (completed) in the state in which the character corresponding to the user input is displayed at operation 611. For example, when the user input for inputting a character is not generated for a certain time, or a direct input for completing a character input is entered, it may be determined that the user input for inputting a character is released.

When it is determined the user input is not released (NO of operation 611), the controller 170 may proceed to operation 609 to control to perform the display of the character. When it is determined the user input is released (YES of operation 611), the controller 170 may control to display the cursor handle again at operation 613. For example, the controller 170 may generate and display the cursor handle in an end area (e.g., the rightmost area of the displayed character) of the character in the state in which the character corresponding to the user input is displayed.

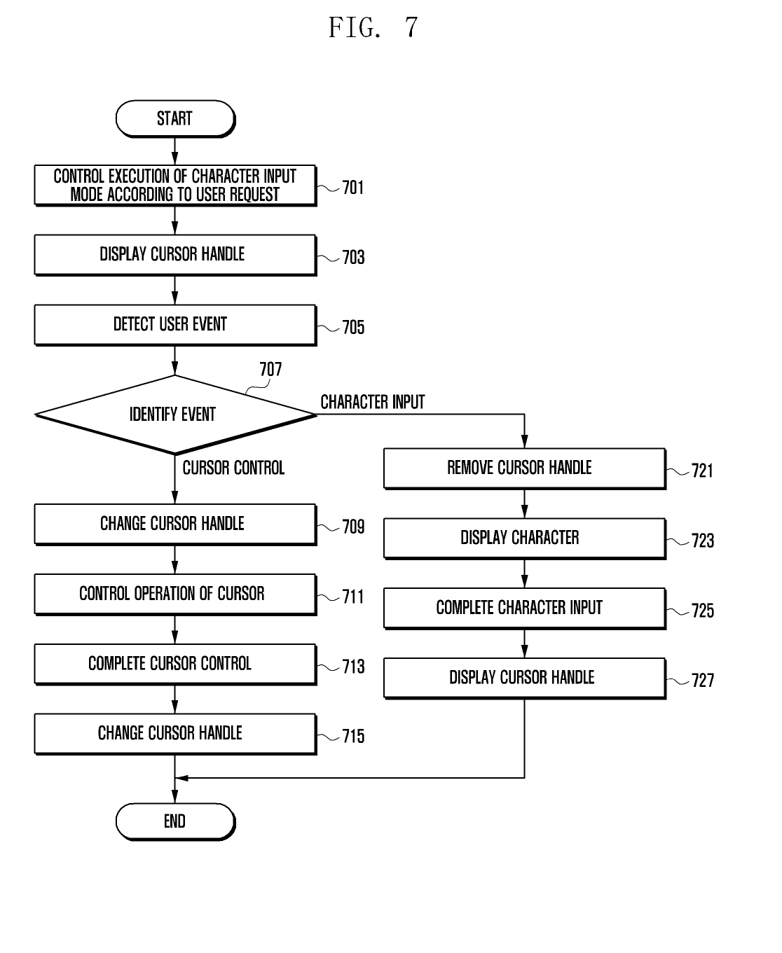

FIG. 7 is a flowchart illustrating a method of operating a cursor handle in an electronic device according to an embodiment of the present disclosure.

Referring to FIG. 7, a method, where a controller 170 may control to execute a character input mode according to a request of a user at operation 701, is illustrated. The controller 170 may control to display a cursor handle of a preset default shape on a screen when executing the character input mode at operation 703.

When an event is detected from the user in the character input mode that provides the cursor handle at operation 705, the controller 170 may determine whether the event is a user input for cursor control, or a user input for inputting a character by identifying the event at operation 707. For example, when the event corresponding to a hovering or a touch is detected in a location in which the cursor handle is displayed, the controller 170 may determine that the event is a user input for cursor control. When the event by a handwriting or by a keypad is detected, the controller 170 may determine that the event is a user input for inputting a character.

When it is determined that the event is a user input for cursor control, the controller 170 may control to change the cursor handle of default shape into another shape in response to the user input at operation 709. Then, the controller 170 may control the operation of the cursor in response to the user input using a changed cursor handle at operation 711. For example, the controller 170 may control a movement to another location in response to the user input using the changed cursor handle.

Next, when the cursor control by the changed cursor handle is completed at operation 713, the controller 170 may control to change the changed cursor handle into the cursor handle of default shape at operation 715. When it is determined that the event is a user input for inputting a character, the controller 170 may control to remove (dissipate) the cursor handle from the screen in response to the user input at operation 721, and may control to display a character corresponding to the user input at operation 723.

Next, when the user input for inputting a character is completed in a state of displaying a character corresponding to the user input at operation 725, the controller 170 may control to generate the cursor handle in a final area of the character corresponding to the user input to display again at operation 727.

In the meantime, according to various embodiments of the present disclosure, each module may be configured by a software, a firmware, a hardware, or a combination thereof. In addition, some or all modules may be configured in a single entity, but each corresponding module may be configured to perform the same function. In addition, according to various embodiments of the present disclosure, each operation may be implemented sequentially, repeatedly or in parallel. In addition, some operations may be omitted, or other operations may be added to perform.

The foregoing various embodiments of the present disclosure may be implemented in a program command form executable by various computer means and be recorded in a non-transitory computer-readable recording medium. In this case, the computer-readable recording medium may include a program command, a data file, and a data structure individually or a combination thereof. In the meantime, the program command recorded in a recording medium may be specially designed or configured for the present disclosure or be known to a person having ordinary skill in a computer software field to be used. The computer-readable recording medium may be Magnetic Media such as hard disk, floppy disk, or magnetic tape, Optical Media such as Compact Disc Read Only Memory (CD-ROM) or Digital Versatile Disc (DVD), Magneto-Optical Media such as floptical disk, and a hardware device such as ROM. RAM, or flash memory for storing and executing program commands. Further, the program command may include a machine language code created by a compiler and a high-level language code executable by a computer using an interpreter. The foregoing hardware device may be configured to be operated according to at least one software module to perform an operation of the present disclosure, or software modules may be configured to be operated according to the hardware device.

As described above, according to a method and apparatus for operating an input function in an electronic device suggested by the present disclosure, the input function can be operated more conveniently through the cursor handle. According to an embodiment of the present disclosure, the state of the cursor handle can be automatically changed according to a user's input state (e.g., an air view state, or a contact state, etc.) to satisfy a visual effect and a usability.

An embodiment of the present disclosure can display a cursor handle according to a state of user input or remove the displayed cursor, and support differently a shape (a size, a form, a color, etc.) of the cursor handle according to a state of user input when displaying the cursor handle. For instance, a display of a cursor is removed during an operation of character input by a user in a character input mode, and the cursor handle can be displayed when the operation of character input is completed, and a shape of the cursor handle can be automatically changed and displayed in response to a user input in an operation of the user's cursor control.

Accordingly, the embodiment of the present disclosure can enhance user's ease, and enhance a usability of electronic device, an ease, an accessibility, a visibility, and a competitiveness by implementing an optimal environment for operating an input function by using a cursor in an electronic device.

The present disclosure may be implemented by all kinds of electronic devices such as a mobile communication terminal, a Smart Phone, a tablet PC, a portable game terminal, a PMP, a PDA, a wearable device, etc., and various devices capable of supporting a display function according to various embodiments of the present disclosure.

It will be appreciated that various embodiments of the present disclosure according to the claims and description in the specification can be realized in the form of hardware, software or a combination of hardware and software.

Any such software may be stored in a non-transitory computer readable storage medium. The non-transitory computer readable storage medium stores one or more programs (software modules), the one or more programs comprising instructions, which when executed by one or more processors in an electronic device, cause the electronic device to perform a method of the present disclosure.

Any such software may be stored in the form of volatile or non-volatile storage such as, for example, a storage device like a Read Only Memory (ROM), whether erasable or rewritable or not, or in the form of memory such as, for example, Random Access Memory (RAM), memory chips, device or integrated circuits or on an optically or magnetically readable medium such as, for example, a Compact Disk (CD), Digital Versatile Disc (DVD), magnetic disk or magnetic tape or the like. It will be appreciated that the storage devices and storage media are various embodiments of non-transitory machine-readable storage that are suitable for storing a program or programs comprising instructions that, when executed, implement various embodiments of the present disclosure. Accordingly, various embodiments provide a program comprising code for implementing apparatus or a method as claimed in any one of the claims of this specification and a non-transitory machine-readable storage storing such a program.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of supporting an input function of an electronic device, the method comprising:
executing, by the electronic device, a character input mode;
providing a cursor handle to support an input function in the character input mode; and
changing the cursor handle in response to a user input.

2. The method of claim 1, wherein the changing of the cursor handle further comprises removing the cursor handle from a screen of the electronic device in response to the user input for inputting a character.

3. The method of claim 2, wherein the changing of the cursor handle further comprises displaying the cursor handle on the screen in response to a release of the user input.

4. The method of claim 1, wherein the changing of the cursor handle further comprises changing a shape of the cursor handle in response to the user input for cursor control.

5. The method of claim 4, wherein the user input for cursor control comprises an input due to an air view state or a contact state for the cursor handle.

6. The method of claim 4, wherein the changing of the shape of the cursor handle further comprises changing at least one of a shape, a size, and a color of the cursor handle.

7. The method of claim 1, wherein the changing of the cursor handle further comprises displaying the cursor handle of a first size on a screen of the electronic device in response to a release of the user input, and displaying the cursor handle of a second size greater than the first size when an access of the user input for cursor control is detected.

8. The method of claim 1, wherein the providing of the cursor handle further comprises providing the cursor handle according to a preset method to provide either a display of the cursor handle or an omission of the cursor handle when executing the character input mode.

9. The method of claim 8, wherein the changing of the cursor handle further comprises displaying the cursor handle in response to the user input.

10. The method of claim 9, wherein the changing of the cursor handle further comprises removing the cursor handle from a screen of the electronic device in response to a release of the user input.

11. The method of claim 1, wherein the cursor handle comprises a cursor and a handle, and the cursor handle implements the cursor and the handle as a single item or as separate items.

12. The method of claim 11, wherein the changing of the cursor handle comprises changing the handle of the cursor handle.

13. A method of supporting an input function in an electronic device, the method comprising:
displaying, by the electronic device, a cursor handle in a character input mode;
detecting a user event;
controlling a change corresponding to a display or a removal of the cursor handle in response to the user event, when the user event is an event for inputting a character; and
controlling a change of at least one of a size, a shape, and a color of the cursor handle in response to the user event, when the user event is an event for cursor control.

14. An electronic device comprising:
a display unit configured to display a screen according to a character input mode and a cursor handle for supporting an input function;
a touch sensing unit configured to receive a user input for a character input and a cursor control in the character input mode; and
a controller configured to control a change of the cursor handle in response to the user input in the character input mode.

15. The electronic device of claim 14, wherein the controller is further configured to control the change of the cursor handle according to a preset method from either a display of the cursor handle or an omission of the cursor handle, when executing the character input mode.

16. The electronic device of claim 15, wherein the controller is further configured to control the display of the cursor handle or the omission of the cursor handle in response to the user input for the character input, and to control a shape change of the cursor handle in response to the user input for the cursor control.

17. The electronic device of claim 16, wherein the user input for the cursor control comprises an input due to an air view state or a contact state for the cursor handle.

18. The electronic device of claim 14, wherein the controller is further configured to control a change of at least one of a shape, a size, and a color of the cursor handle in response to the user input.

19. The electronic device of claim 14, wherein the controller is further configured to display the cursor handle of a first size on the screen when a release of the user input is detected by the touch sensing unit, and to display the cursor handle of a second size greater than the first size when an access of the user input for cursor control is detected by the touch sensing unit.

20. The electronic device of claim 14, wherein the cursor handle comprises a cursor and a handle, and the cursor handle implements the cursor and the handle as a single item or as separate items.

21. The electronic device of claim 20, wherein the controller is further configured to control a change of the handle of the cursor handle in response to the user input.

22. The electronic device of claim 14, wherein the user input comprises an input by a handwriting or a keypad.

23. The electronic device of claim 14, wherein the controller is further configured to:
detect a user event;
determine whether the detected user event is a character input or a cursor control;
when the user event is determined to be the character input, remove the cursor handle from the screen, display a character on the screen, complete the character input and display the cursor handle on the screen; and
when the user event is determined to be the cursor control, change the cursor handle displayed on the screen, control an operation of the cursor, complete a control of the cursor and subsequently change the cursor handle displayed on the screen.

24. At least one non-transitory processor readable medium for storing a computer program of instructions configured to be readable by at least one processor for instructing the at least one processor to execute a computer process for performing the method as recited in claim 1.
